(19) United States
(12) Patent Application Publication
(10) Pub. No.: US 2025/0020987 A1
(43) Pub. Date: Jan. 16, 2025

(54) OPTICAL PHASE MODULATION SYSTEM AND DISPLAY UNIT

(71) Applicant: SONY GROUP CORPORATION, TOKYO (JP)

(72) Inventors: NARIYASU SUGAWARA, TOKYO (JP); AKIKO TORIYAMA, TOKYO (JP); SHINICHIRO TAJIRI, TOKYO (JP)

(21) Appl. No.: 18/712,391

(22) PCT Filed: Oct. 18, 2022
(86) PCT No.: PCT/JP2022/038770

§ 371 Date: May 22, 2024

(30) Foreign Application Priority Data
Nov. 30, 2021 (JP) 2021-194909

(51) Int. Cl. G03B 21/20; G03B 21/00; G02F 1/133

(52) U.S. Cl. CPC G03B 21/2073; G03B 21/006; G02F 1/13306

(57) ABSTRACT

An optical phase modulation system of the present disclosure includes an illumination light emitter, a phase modulation unit, and a synchronization control unit. The illumination light emitter performs polarization control on a polarization direction of light emitted as illumination light into a first polarization direction and a second polarization direction different from the first polarization direction, and emits light having the first polarization direction and light having the second polarization direction at different timing and in different directions from each other. The phase modulation unit includes a first region that performs phase modulation on the light having the first polarization direction from the illumination light emitter, and a second region that performs phase modulation on the light having the second polarization direction from the illumination light emitter. The synchronization control unit causes timing at which the light having the first polarization direction and the light having the second polarization direction are emitted from the illumination light emitter to be synchronized with timing of phase modulation in the first region and the second region of the phase modulation unit.

### TECHNICAL FIELD

The present disclosure relates to an optical phase modulation system and a display unit.

### BACKGROUND ART

Typically, in a liquid crystal optical phase modulation device, a thickness of a liquid crystal layer is doubled to secure a phase modulation amount (0 to 2π) that is twice that of a liquid crystal luminance modulation device. As a principle characteristic of a liquid crystal, a response speed is proportional to a square of the thickness of the liquid crystal layer. Thus, the response speed of the optical phase modulation device is four times slower than that of the luminance modulation device. Given this fact, a technology has been proposed that makes the response speed to be equivalent to that of a normal luminance modulation device while achieving a normal phase modulation amount (0 to 2π) by disposing, in an optical path, two optical phase modulation devices having a phase modulation amount of 0 to π with a thickness equivalent to that of the luminance modulation device (see PTL 1).

### CITATION LIST

### Patent Literature

PTL 1: Japanese Unexamined Patent Application Publication No. 2014-66869

### SUMMARY OF THE INVENTION

When two optical phase modulation devices are disposed in the same optical path, the distance used to dispose the two optical phase modulation devices is increased. Additionally, because a phase of light that enters a second optical phase modulation device is no longer a plane, it becomes very difficult to control a phase plane, which leads to degradation in image quality.

It is desirable to provide an optical phase modulation system and a display unit that make it possible to suppress degradation in image quality while improving a response speed of phase modulation.

An optical phase modulation system according to an embodiment of the present disclosure includes an illumination light emitter, a phase modulation unit, and a synchronization control unit. The illumination light emitter is configured to perform polarization control on a polarization direction of light emitted as illumination light into a first polarization direction and a second polarization direction different from the first polarization direction, and configured to emit light having the first polarization direction and light having the second polarization direction at different timing from each other and in different directions from each other. The phase modulation unit includes a first region configured to perform phase modulation on the light having the first polarization direction from the illumination light emitter, and a second region configured to perform phase modulation on the light having the second polarization direction from the illumination light emitter. The synchronization control unit causes timing at which the light having the first polarization direction and the light having the second polarization direction are emitted from the illumination light emitter to be synchronized with timing of phase modulation in the first region and the second region of the phase modulation unit.

A display unit includes an illumination light emitter, a phase modulation unit, and a synchronization control unit. The illumination light emitter is configured to perform polarization control on a polarization direction of light emitted as illumination light into a first polarization direction and a second polarization direction different from the first polarization direction, and configured to emit light having the first polarization direction and light having the second polarization direction at different timing from each other and in different directions from each other. The phase modulation unit includes a first region configured to perform phase modulation on the light having the first polarization direction from the illumination light emitter, and a second region configured to perform phase modulation on the light having the second polarization direction from the illumination light emitter. The synchronization control unit causes timing at which the light having the first polarization direction and the light having the second polarization direction are emitted from the illumination light emitter to be synchronized with timing of phase modulation in the first region and the second region of the phase modulation unit.

In the optical phase modulation system or the display unit according to one embodiment of the present disclosure, light having the first polarization direction and light having the second polarization direction are emitted from the illumination light emitter at different timing, and the light having the first polarization direction and the light having the second polarization direction are respectively phase-modulated in the first region and the second region of the phase modulation unit. At this time, the timing of emitting light having each polarization direction is caused to be synchronized with the timing of the phase modulation in each region.

### BRIEF DESCRIPTION OF DRAWINGS

FIG. 1 is a perspective view illustrating an outline of a display unit that uses a luminance modulation method.

FIG. 2 is a cross-sectional view illustrating an outline of the display unit that uses the luminance modulation method.

FIG. 3 is a perspective view illustrating an outline of a display unit that uses a phase modulation method.

FIG. 4 is a cross-sectional view illustrating an outline of the display unit that uses the phase modulation method.

FIG. 5 is a cross-sectional view illustrating a comparison between a configuration of a liquid crystal luminance modulation device and a configuration of a liquid crystal optical phase modulation device.

FIG. 6 is a cross-sectional view schematically illustrating a configuration example of an optical phase modulation system according to a comparative example.

FIG. 7 is an explanatory diagram illustrating an issue of the optical phase modulation system illustrated in FIG. 6.

FIG. 8 is a configuration diagram illustrating an outline of an optical phase modulation system according to a first embodiment of the present disclosure.

FIG. 9 is a plan view schematically illustrating a configuration example of a phase modulation unit in the optical phase modulation system according to the first embodiment.

FIG. 10 is a plan view schematically illustrating a configuration example of a phase modulation unit and an illumination light emitter in the optical phase modulation system according to the first embodiment.

FIG. 11 is an explanatory diagram illustrating an example of a driving state of the phase modulation unit in the optical phase modulation system according to the first embodiment.

FIG. 12 is an explanatory diagram illustrating an example of a rising response speed of the liquid crystal luminance modulation device and the liquid crystal optical phase modulation device.

FIG. 13 is an explanatory diagram illustrating an example of a falling response speed of the liquid crystal luminance modulation device and the liquid crystal optical phase modulation device.

FIG. 14 is an explanatory diagram illustrating a first example of a driving state of an optical phase modulation device according to a comparative example.

FIG. 15 is an explanatory diagram illustrating a second example of a driving state of an optical phase modulation device according to a comparative example.

FIG. 16 is an explanatory diagram illustrating an example of a driving state of the phase modulation unit in the optical phase modulation system according to the first embodiment.

FIG. 17 is a cross-sectional view schematically illustrating a configuration example of an optical phase modulation system according to Modification Example 1.

FIG. 18 is a cross-sectional view schematically illustrating a configuration example of an optical phase modulation system according to Modification Example 2.

FIG. 19 is a cross-sectional view schematically illustrating a configuration example of an optical phase modulation system according to Modification Example 3.

FIG. 20 is a cross-sectional view schematically illustrating a first configuration example of a polarization spectroscopy device.

FIG. 21 is a perspective view schematically illustrating a second configuration example of the polarization spectroscopy device.

FIG. 22 is a cross-sectional view schematically illustrating a configuration example of an optical phase modulation system according to Modification Example 4.

FIG. 23 is a cross-sectional view schematically illustrating a configuration example of an optical phase modulation system according to Modification Example 5.

FIG. 24 is a cross-sectional view schematically illustrating a configuration example of an optical phase modulation system according to Modification Example 6.

FIG. 25 is a cross-sectional view schematically illustrating a configuration example of an optical phase modulation system according to Modification Example 7.

FIG. 26 is a cross-sectional view schematically illustrating a configuration example of an optical phase modulation system according to Modification Example 8.

FIG. 27 is a cross-sectional view schematically illustrating a configuration example of an optical phase modulation system according to Modification Example 9.

FIG. 28 is a cross-sectional view schematically illustrating a configuration example of an optical phase modulation system according to Modification Example 10.

### MODES FOR CARRYING OUT THE INVENTION

In the following, embodiments of the present disclosure will be described in detail with reference to the drawings. Note that the description is given in the following order.

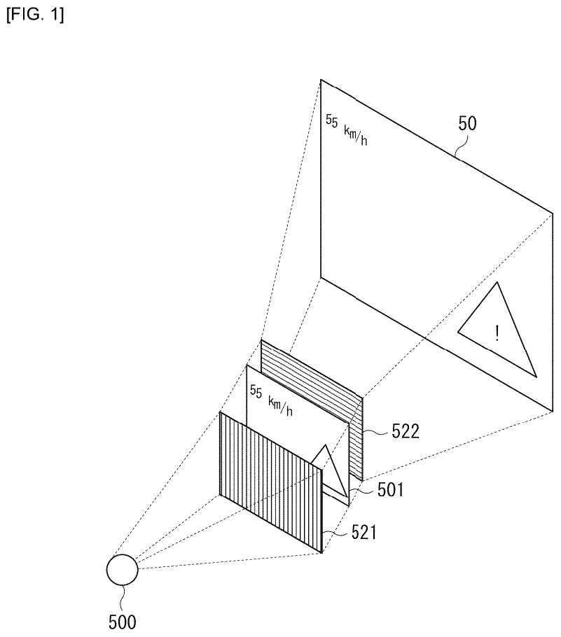

### 0. Comparative Examples and Background (FIGS. 1 to 7)

### 1. First Embodiment

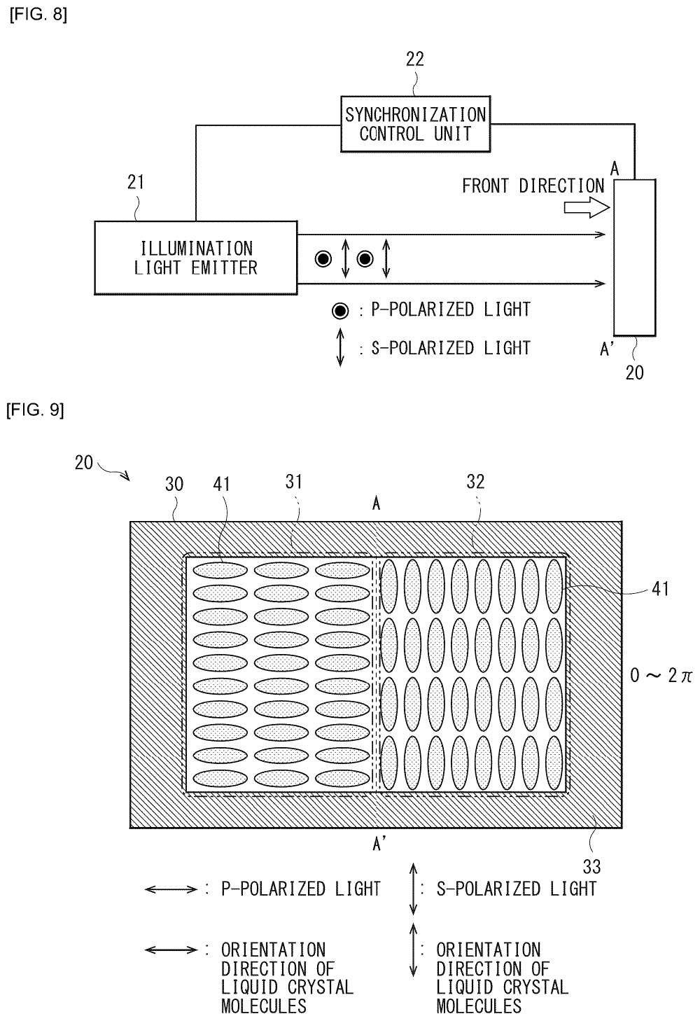

1.1 Configuration and Operation (FIGS. 8 to 16)
1.2 Modification Examples (FIGS. 17 to 28)
1.3 Effects

### 2. Other Embodiments

### <0. Comparative Examples and Background>

### (Display Unit That Uses Luminance Modulation Method and Display Unit That Uses Phase Modulation Method)

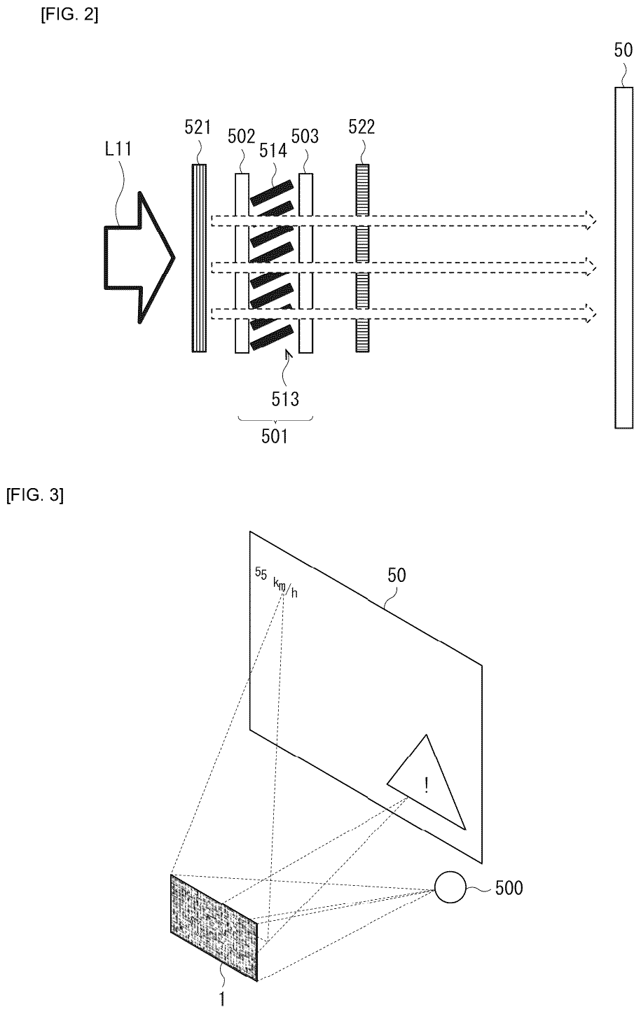

FIGS. 1 and 2 illustrate an outline of a display unit that uses a luminance modulation method.

As a configuration of a typical projection display unit (projector), for example, as illustrated in FIGS. 1 and 2, there is one that irradiates a light intensity modulation device 501 with uniform illumination light emitted from a light source 500, performs light intensity modulation, generates an image, and projects the generated image onto a screen 50 through a projection lens.

Normally, a LCD (Liquid Crystal Display: liquid crystal panel) or a DMD (Digital Micro-mirror Device: mirror device) is used as the light intensity modulation device 501. In particular, a liquid crystal projector using a liquid crystal panel has good color reproducibility and makes it possible to achieve high image quality. The liquid crystal projector uses the liquid crystal panel as an optical shutter. FIGS. 1 and 2 illustrate an example in which a transmissive liquid crystal panel is used as the light intensity modulation device 501. The liquid crystal panel has a configuration in which a liquid crystal layer 513 including a plurality of liquid crystal molecules 514 is sandwiched between a pair of substrates 502 and 503. When the light intensity modulation device 501 is a transmissive liquid crystal panel, a polarizer 521 is disposed in a light entering direction, and an analyzer 522 is disposed in a light emitting direction. The polarizer 521 emits polarized light that is polarized in a predetermined polarization direction out of entering light L11. In a case of the display unit that uses the luminance modulation method, one pixel of the light intensity modulation device 501 corresponds to one pixel of an image to be finally displayed. In a case where the light intensity modulation device 501 is a liquid crystal panel, when a dark image region is displayed, it is necessary to block the illumination light by the liquid crystal panel, and there is light that is not used for the display. This significantly lowers use efficiency of light.

In contrast, as a display unit that uses a phase modulation method, there is a technology of generating illumination light using SLM (Spatial Light Modulator: spatial optical phase modulation device) as a diffraction device, and thereby distributing a part of light irradiated on a pixel region of low luminance to a high luminance region.

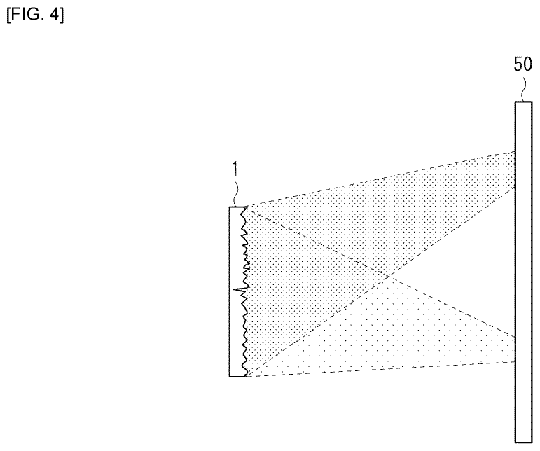

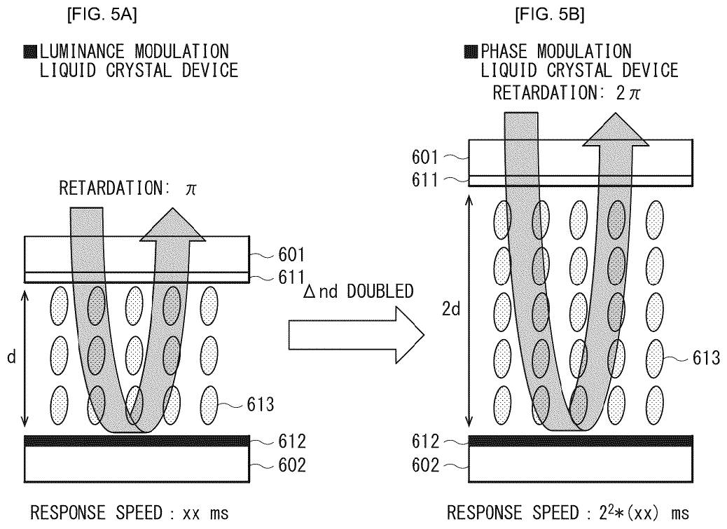

FIGS. 3 and 4 illustrate an outline of a display unit that uses the phase modulation method.

FIGS. 3 and 4 illustrate an example in which a reflective diffraction device is used as an optical phase modulation device 1. In the display unit that uses the phase modulation method, for example, a reproduced image generated by irradiating the optical phase modulation device 1 with uniform illumination light emitted from the light source 500 and performing phase modulation is projected on the screen 50. The display unit that uses the phase modulation method is highly efficient because diffraction of light is used. In the case of the display unit that uses the phase modulation method, one pixel of the optical phase modulation device 1 does not necessarily correspond to one pixel of an image to be finally displayed, and it is possible to make a plurality of pixels in the optical phase modulation device 1 to correspond to one pixel of an image to be displayed. Because it is possible to configure one pixel of the image to be finally displayed using a plurality of pixels in the optical phase modulation device 1, it is also a feature that a pixel display is stable even if a pixel defect occurs in the optical phase modulation device 1. Further, a technology is also disclosed in which a color display is also possible, and illumination light of three primary colors of R (red), G (green), and B (blue) is generated using the optical phase modulation device 1 different for each color.

As the optical phase modulation device 1, it is also possible to use a liquid crystal optical phase modulation device. It is possible to obtain a desired reproduced image by calculating a phase distribution pattern (phase hologram) corresponding to a desired reproduced image and displaying the calculated pattern on the liquid crystal optical phase modulation device. (Liquid Crystal Luminance Modulation Device and Liquid Crystal Optical Phase Modulation Device)

FIG. 5 illustrates a comparison between a configuration of a liquid crystal luminance modulation device (FIG. 5(A)) and a configuration of a liquid crystal optical phase modulation device (FIG. 5(B)).

FIG. 5 illustrates a configuration example of a reflective type. Both the luminance modulation device and the optical phase modulation device have a configuration in which liquid crystal molecules 613 are sealed between two opposing substrates 601 and 602. A pixel electrode (transparent electrode) 611 is provided on a side of the substrate 601 opposed to the liquid crystal layer, and a pixel electrode (reflective electrode) 612 is provided on a side of the substrate 601 opposed to the liquid crystal layer.

Typically, in the liquid crystal optical phase modulation device, a thickness (cell gap) d of the liquid crystal layer is doubled to secure a phase modulation amount (0 to 2π) that is twice that of the liquid crystal luminance modulation device. As a principle characteristic of the liquid crystal, a response speed is proportional to a square of the thickness of the liquid crystal layer. Thus, the response speed of the optical phase modulation device is four times slower than that of the luminance modulation device. To address this situation, normally, in the display unit that uses the phase modulation method, a countermeasure such as using an optical phase modulation device or turning off illumination may be taken although it is known that the image quality will degrade. In this case, a frame speed, the image quality, and luminance will degrade.

In the liquid crystal luminance modulation device, it is sufficient that a retardation Δnd=π is secured for any wavelength λ, whereas in the phase modulation liquid crystal device, a retardation Δnd=2π needs to be secured for the wavelength λ. Typically, it is known that a rising response speed of a nematic liquid crystal is expressed by the following expression (1), and a falling response speed is expressed by the following expression (2). In the expressions (1) and (2), γ is rotational viscosity, co is dielectric constant of vacuum, As is dielectric anisotropy, d is cell gap, V is applied voltage, and Vₜₕ is rotational viscosity.

$$\begin{matrix}[ Expression 1 ] & \\ {τ}_{rise} ∝ \frac{{γ}_{1} {d}^{2}}{{ε}_{0} \vert Δε \vert ( {V}^{2} - {V}_{{th}^{2}} )} & ( 1 )\end{matrix}$$

$$\begin{matrix}[ Expression 2 ] & \\ {τ}_{fall} ∝ \frac{{γ}_{1} {d}^{2}}{{ε}_{0} \vert Δε \vert {V}_{th}^{2}} & ( 2 )\end{matrix}$$

When the thickness of the liquid crystal layer is doubled to secure a retardation of 2πaccording to the expressions (1) and (2), both the rising response speed and the falling response speed are slowed by a factor of 22=4. Thus, for example, there is a limited possibility of applying the liquid crystal optical phase modulation device to a ranging technology such as a field sequential holographic display or LiDAR (Light Detection and Ranging), which requires a high-speed response.

For issues of the response speed as described above, PTL 1 (Japanese Unexamined Patent Application Publication No. 2014-66869) proposes a technology that makes the response speed to be equivalent to that of a normal luminance modulation device while achieving a normal phase modulation amount (0 to 2π) by disposing, in an optical path, two optical phase modulation devices having a phase modulation amount of 0 to π with a thickness equivalent to that of the luminance modulation device.

FIG. 6 illustrates an outline of an optical phase modulation system according to the technology described in PTL 1 as a comparative example. The optical phase modulation system includes a first optical phase modulation device 121 having a phase modulation amount of 0 to 1 and a second optical phase modulation device 122 having a phase modulation amount of 0 to π as a reflective liquid crystal optical phase modulation device. A polarization beam splitter 130, a first quarter-wave plate 141, and a second quarter-wave plate 142 are disposed between the first optical phase modulation device 121 and the second optical phase modulation device 122. In this optical phase modulation system, first, entering light Lin to the polarization beam splitter 130 passes through the first quarter-wave plate 141 and is phase-modulated by the first optical phase modulation device 121. Light that is phase-modulated by the first quarter-wave plate 141 passes through the first quarter-wave plate 141, the polarization beam splitter 130, and the second quarter-wave plate 142 and is phased-modulated by the second optical phase modulation device 122. The light that is phase-modulated by the second optical phase modulation device 122 passes through the second quarter-wave plate 142 and the polarization beam splitter 130 and is emitted as emission light Lout.

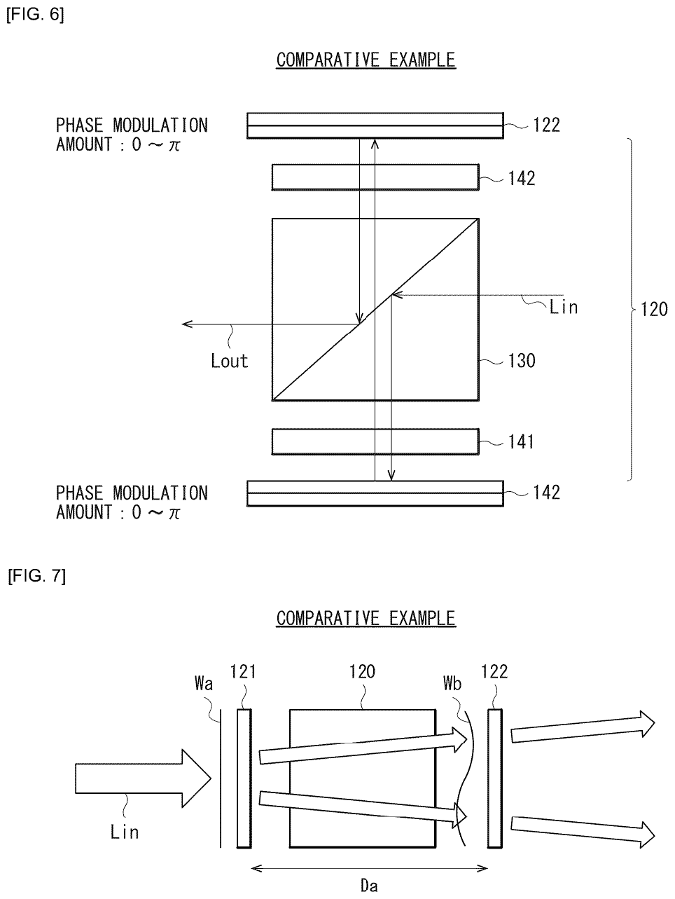

FIG. 7 illustrates an issue of the optical phase modulation system illustrated in FIG. 6. In the optical phase modulation system illustrated in FIG. 6, to use the two optical phase modulation devices 121 and 122 in the same optical path, a distance Da is necessary between the optical phase modulation devices 121 and 122 to dispose an optical device 120 therebetween. Accordingly, even when a wavefront Wa of the entering light Lin is a plane, a wavefront Wb at a stage of entering the second optical phase modulation device 122 is no longer a plane, which makes it very difficult to control a phase plane. It is also difficult to calculate a phase pattern to be displayed on each of the optical phase modulation devices.

### <1. First Embodiment>

### [1.1 Configuration and Operation]

### (Outline of Optical Phase Modulation System)

FIG. 8 illustrates an outline of the optical phase modulation system according to the first embodiment of the present disclosure.

The optical phase modulation system according to the first embodiment includes a phase modulation unit 20, an illumination light emitter 21, and a synchronization control unit 22.

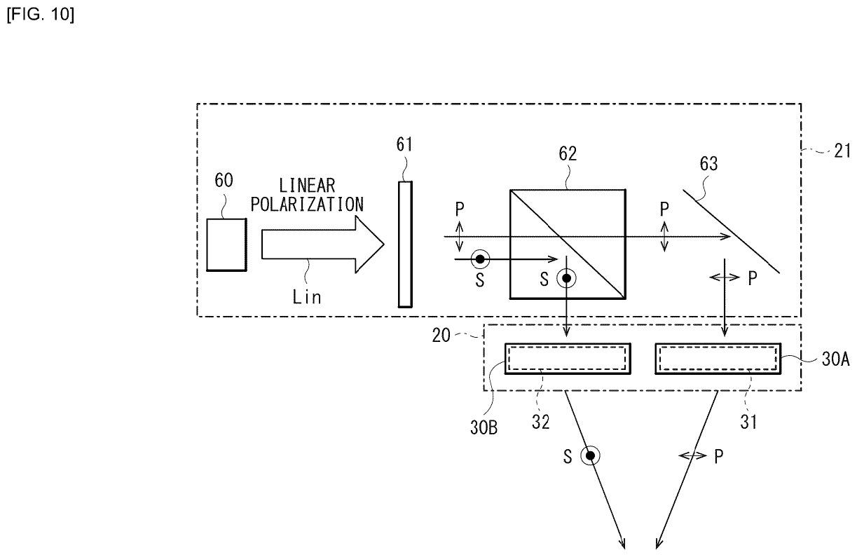

FIG. 9 schematically illustrates a configuration example of the phase modulation unit 20. FIG. 10 schematically illustrates a configuration example of the phase modulation unit 20 and the illumination light emitter 21.

The phase modulation unit 20 includes a first region 31 configured to perform phase modulation on light having a first polarization direction (for example, P-polarized light) from the illumination light emitter 21, and a second region 32 configured to perform phase modulation on light having a second polarization direction (for example, S-polarized light) from the illumination light emitter 21.

FIG. 9 illustrates an example in which the phase modulation unit 20 includes one liquid crystal optical phase modulation device 30 including the first region 31 and the second region 32. Note that, for example, a position A and a position A′ in the phase modulation unit 20 of FIG. 8 correspond to a position A and a position A′ in the optical phase modulation device 30 of FIG. 9. For example, the optical phase modulation device 30 includes an effective pixel region and a peripheral region 33. The optical phase modulation device 30 has a structure in which the effective pixel region is divided into the first region 31 and the second region 32. In the optical phase modulation device 30, orientation directions of liquid crystal molecules 41 are different between the first region 31 and the second region 32. In the configuration example of FIG. 9, the effective pixel region is divided into left and right. A divided region on the left is set to be the first region 31, and the orientation direction of the liquid crystal molecules 41 is set to be parallel to a long side of the optical phase modulation device 30. Meanwhile, a divided region on the right is set to be the second region 32, and the orientation direction of the liquid crystal molecules 41 is set to be perpendicular to the long side of the optical phase modulation device 30. Thus, it is possible to perform the phase modulation on the P-polarized light in the first region 31, and it is possible to perform the phase modulation on the S-polarized light in the second region 32. Note that a method and a shape of the division of the effective pixel region are not limited to the configuration example of FIG. 9, and may be other dividing methods and shapes.

Alternatively, as in a configuration example illustrated in FIG. 10, the phase modulation unit 20 may include a first optical phase modulation device 30A and a second optical phase modulation device 30B. In this case, the orientation direction of the entire effective pixel region in the first optical phase modulation device 30A may be similar to that of the first region 31 of the optical phase modulation device 30 described above. Further, the orientation direction of the entire effective pixel region in the second optical phase modulation device 30B may be similar to that of the second region 32 of the optical phase modulation device 30 described above. This may make it possible for the phase modulation to be performed on the P-polarized light in the first optical phase modulation device 30A (the first region 31). This may also make it possible for the phase modulation to be performed on the S-polarized light in the second optical phase modulation device 30B (the second region 32).

The illumination light emitter 21 is configured to perform polarization control on the polarization direction of light emitted as the illumination light into a first polarization direction (for example, the P-polarized light) and a second polarization direction (for example, the S-polarized light) different from the first polarization direction. Additionally, the illumination light emitter 21 is configured to emit the light having the first polarization direction and the light having the second polarization direction at different timing from each other and in different directions from each other.

The illumination light emitter 21 includes, for example, a polarization rotation device that performs the polarization control on the polarization direction of light into the first polarization direction and the second polarization direction, and an optical path branching device that causes an optical path to be branched into an optical path of light having the first polarization direction and an optical path of light having the second polarization direction.

The synchronization control unit 22 causes timing at which the light having the first polarization direction and the light having the second polarization direction are emitted from the illumination light emitter 21 to be synchronized with timing of the phase modulation in the first region 31 and the second region 32 of the phase modulation unit 20. The synchronization control unit 22 causes the timing at which the light having the first polarization direction is emitted from the illumination light emitter 21 to be synchronized with the timing at which the phase modulation of the light having the first polarization direction is performed in the first region 31. Further, the timing at which the light having the second polarization direction is emitted from the illumination light emitter 21 is caused to be synchronized with the timing at which the phase modulation of the light having the second polarization direction is performed in the second region 32.

In the configuration example illustrated in FIG. 10, the illumination light emitter 21 includes a light source 60, a polarization rotation device 61, a polarization beam splitter (PBS) 62, and a mirror 63. The polarization rotation device 61 is a device configured to electrically rotate the polarization direction of light, and is, for example, a liquid crystal device (for example, a ferroelectric liquid crystal device). The polarization beam splitter 62 is an optical path branching device that causes an optical path to be branched into an optical path of light having the first polarization direction and an optical path of light having the second polarization direction. The light source 60 is, for example, a laser light source that emits linearly polarized light.

In the configuration example illustrated in FIG. 10, the linearly polarized light from the light source 60 enters the polarization rotation device 61 as the entering light Lin. The polarization rotation device 61 performs the polarization control on the polarization direction of the entering light Lin into the P-polarized light and the S-polarized light, and emits the P-polarized light and the S-polarized light. The P-polarized light enters the first region 31 (the first optical phase modulation device 30A) of the phase modulation unit 20 via the polarization beam splitter 62 and the mirror 63, and is phase-modulated in the first region 31. The S-polarized light enters the second region 32 (the second optical phase modulation device 30B) of the phase modulation unit 20 via the polarization beam splitter 62, and is phase-modulated in the second region 32. The P-polarized light and the S-polarized light after the phase modulation are emitted in the same direction to form a reproduced image corresponding to a phase modulation pattern.

The synchronization control unit 22 causes timing of the polarization control performed by the polarization rotation device 61 to be synchronized with the timing of the phase modulation in the first region 31 and the second region 32 of the phase modulation unit 20. The illumination light emitted from the polarization rotation device 61 illuminates either the first region 31 or the second region 32 of the phase modulation unit 20 in accordance with the polarization direction thereof. The synchronization control unit 22 controls the polarization rotation device 61 to rotate the polarization direction of the illumination light in accordance with a response completion time of the liquid crystal in each of the first region 31 and the second region 32. Thus, the phase modulation pattern is displayed in each of the first region 31 and the second region 32 alternately.

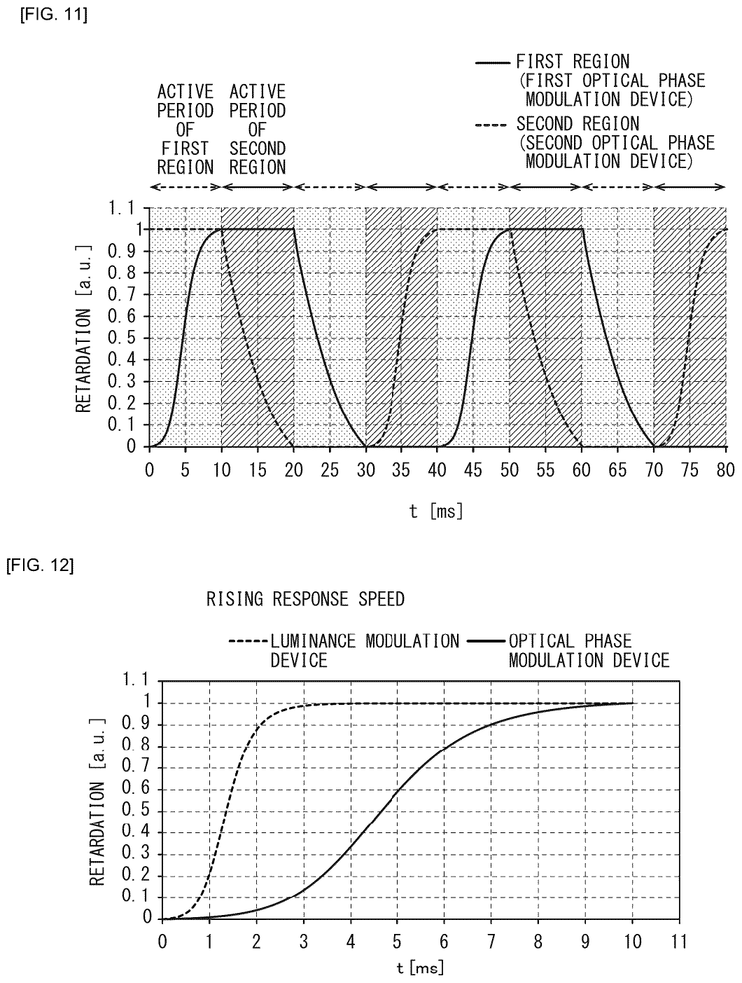

FIG. 11 illustrates an example of a driving state (a state of a liquid crystal response) of the phase modulation unit 20 in the optical phase modulation system illustrated in FIG. 10. In FIG. 11, a horizontal axis represents time, and a vertical axis represents retardation. Note that, FIG. 11 illustrates an example in which retardation values of 1.0 and 0 are alternately displayed in each of the first region 31 (the first optical phase modulation device 30A) and the second region 32 (the second optical phase modulation device 30B).

As described above, in the optical phase modulation system according to the first embodiment, by alternately using the first region 31 and the second region 32 of the phase modulation unit 20, it is possible to drive the liquid crystal at a speed twice that of an existing phase modulation unit 20 as a whole. At this time, of the first region 31 and the second region 32, noise light generated from a pixel region in a refresh state is ideally all Oth order light because the direction of the linear polarization is switched to a direction in which an in-plane phase distribution does not occur. This makes it possible to easily remove the noise light by installing a spatial filter that filters out Oth order light in a latter stage of the phase modulation unit 20. Additionally, even in an application in which a static reproduced image is continuously outputted, it is possible to reduce deterioration in the image quality due to speckles because the linear polarization direction is rotated by 90° in each frame.

### (Liquid Crystal Response Speed of Phase Modulation Unit 20)

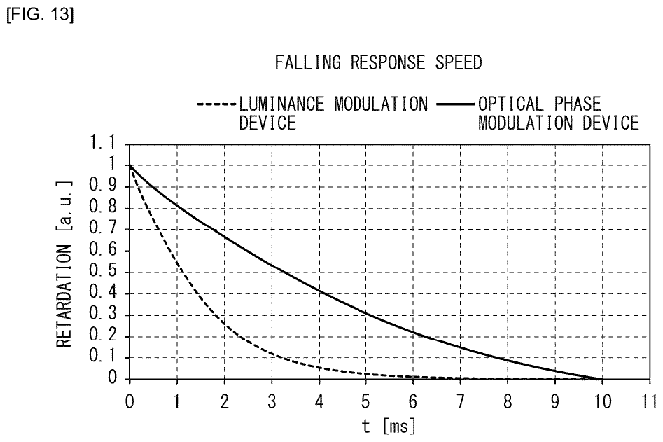

FIG. 12 illustrates an example of the rising response speed of the liquid crystal luminance modulation device and the liquid crystal optical phase modulation device. FIG. 13 illustrates an example of the falling response speed of the liquid crystal luminance modulation device and the liquid crystal optical phase modulation device.

A current situation of the response speed that the present technology attempts to solve will be summarized again. As described above, it is necessary for the liquid crystal optical phase modulation device to secure twice the retardation compared with the liquid crystal luminance modulation device. This causes an issue that the response speed is slowed down. FIGS. 12 and 13 illustrate an example of the response speed when the thickness of the liquid crystal layer in the liquid crystal optical phase modulation device is changed to be twice the thickness of the liquid crystal layer in the liquid crystal luminance modulation device. By increasing the thickness of the liquid crystal layer in accordance with the above-described theoretical expressions (1) and (2), the response speed is slowed down at both a rising edge and a falling edge. In a case where a desired reproduced image is outputted using the liquid crystal optical phase modulation device, it is imaginable as a factor that a large deviation from an ideal phase distribution occurs in a transient state, and the deviation of the phase distribution leads to a decrease in diffraction efficiency and deterioration in the image quality.

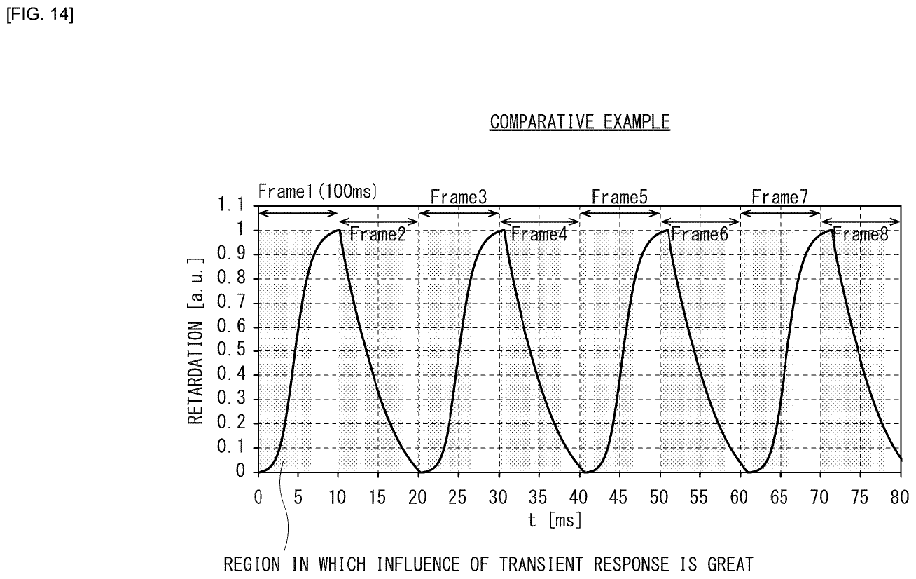

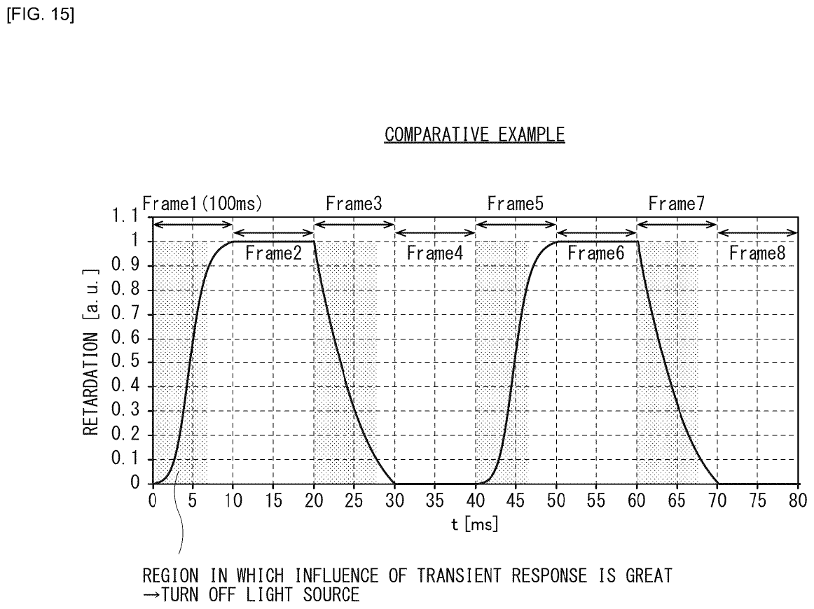

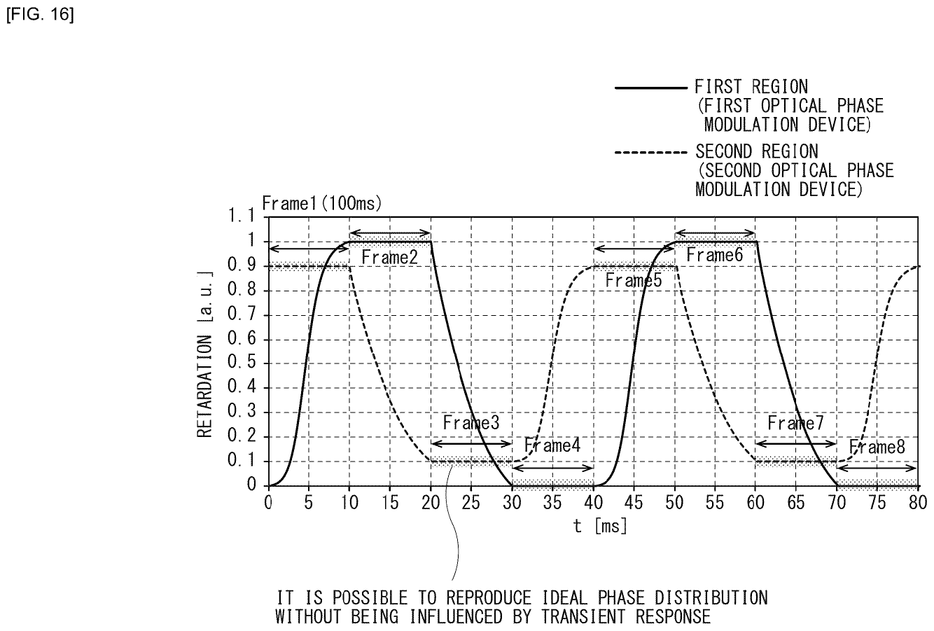

FIG. 14 illustrates a first example of a driving state of an optical phase modulation device according to a comparative example.

Consideration is given on the response of the liquid crystal in a case where an attempt is made to drive a liquid crystal optical phase modulation device that uses an existing method at 100 Hz. FIG. 14 illustrates a behavior of the liquid crystal response for eight frames. One frame corresponds to 10 ms because the liquid crystal optical phase modulation device is driven at 100 Hz. Here, consideration is given on a case where desired retardation values of 1.0 and 0 are alternately displayed per 10 ms. Here, consideration is given on the basis of a VA (Vertical Alignment) mode in which a rotational angle of the nematic liquid crystal is controlled by a vertical electric field mode. First, a voltage of a certain magnitude is applied at t=0 ms and reaches a value that is 90% of a target retardation value at a point in time t˜ 7 ms. After that, the frame is switched to a next frame, or Frame 2, at a point in time t=10 ms at which there is no more application of the voltage. Thus, the liquid crystal transitions to a tilt angle of the liquid crystal that achieves a next phase distribution by an anchoring energy of an alignment film. At this time, it is obvious that the retardation value from a point in time 0 ms at which the application of the voltage is started up to approximately 7 ms at which the desired retardation value is generally achieved significantly differs from a target value, and thus it is not possible to achieve a target phase distribution. This reduces the diffraction efficiency and deteriorates the image quality of the reproduced image.

Next, consideration is given on a case of the falling response in Frame 2. It can be seen from FIG. 14 that at a point in time t=20 ms there is no more voltage application, and at a point in time t˜ 18 ms there is a settlement at generally the target retardation value. At this time, as in the case of Frame 1, influence of the transient response is great during approximately 8 ms after the applied voltage is changed, which causes deterioration in the image quality. Similarly in the following frames, there is an issue that each time the frame is switched, the influence of the transient response is great, which causes a decrease in the diffraction efficiency and deterioration in the image quality.

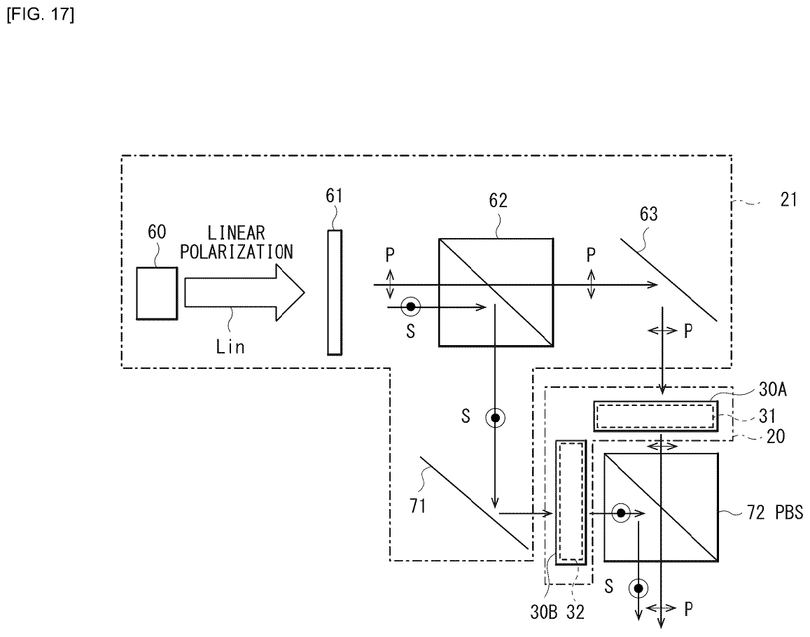

FIG. 15 illustrates a second example of a driving state of an optical phase modulation device according to a comparative example.

For the issues described above with reference to FIG. 14, by applying the same voltage to the liquid crystal layer per two frames, it is possible to extend a time period in which the target retardation value is stably obtainable, and to minimize the influence of the transient response of the liquid crystal on the reproduced image. Further, at this time, by turning off the light source in a transient response region, it is possible to further reduce the degree of influence on deterioration in the image quality of the reproduced image. In this case, however, there is an issue that light use efficiency is reduced, or applicability to applications requiring high-speed driving, such as LiDAR or field sequential holographic displays, is limited.

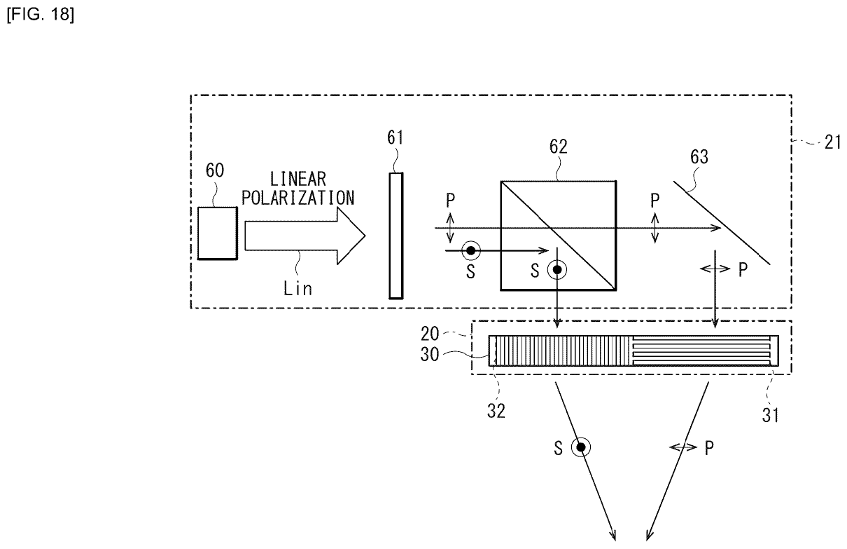

FIG. 16 illustrates an example of a driving state of the phase modulation unit 20 in the optical phase modulation system according to the first embodiment.

In the optical phase modulation system according to the first embodiment, it is possible to solve the above issues by alternately using the first region 31 and the second region 32 of the phase modulation unit 20. As illustrated in FIG. 16, for example, by adopting a sub-frame concept of dividing the frames in 20 ms into a time period in which the first region 31 is used and a time period in which the second region 32 is used, it is possible to prevent a decrease in the diffraction efficiency and deterioration in the image quality of the reproduced image due to the influence of the transient response. Note that FIG. 16 illustrates an example in which 1.0 and 0 are alternately displayed as the retardation values in the first region 31, and 0.9 and 0.1 are alternately displayed as the retardation values in the second region 32. For example, in Frame 1, the second region 32 is used between t=0 to 10 ms, and the first region 31 is used between t=10 to 20 ms. Thus, each region sufficiently passes the transient response and achieves a stable retardation value in an effective time during which the reproduced image is actually displayed. In the subsequent frames also, by adopting a sub-frame driving concept, it is possible to reduce the influence of the transient response and to prevent degradation in the image quality of the reproduced image. Additionally, because out of light intensity of a finally reproduced image, half of the linearly polarized light is orthogonal to the other half of the linearly polarized light, it is possible to also reduce the influence in the deterioration of the reproduced image due to speckles.

### [1.2 Modification Examples]

### (Modification Example 1)

FIG. 17 schematically illustrates a configuration example of an optical phase modulation system according to Modification Example 1.

In the optical phase modulation system according to Modification Example 1, the illumination light emitter 21 includes a mirror 71 in addition to the configuration example illustrated in FIG. 10. Further, in addition to the configuration example illustrated in FIG. 10, a polarization beam splitter (PBS) 72 is disposed on a side of the phase modulation unit 20 on which light is emitted.

In the optical phase modulation system according to Modification Example 1, the linearly polarized light from the light source 60 enters the polarization rotation device 61 as the entering light Lin. The polarization rotation device 61 performs the polarization control on the polarization direction of the entering light Lin into the P-polarized light and the S-polarized light, and emits the P-polarized light and the S-polarized light. The P-polarized light enters the first region 31 (the first optical phase modulation device 30A) of the phase modulation unit 20 via the polarization beam splitter 62 and the mirror 63, and is phase-modulated in the first region 31. The S-polarized light enters the second region 32 (the second optical phase modulation device 30B) of the phase modulation unit 20 via the polarization beam splitter 62 and the mirror 71, and is phase-modulated in the second region 32. The P-polarized light and the S-polarized light after the phase modulation are emitted in the same direction through the polarization beam splitter 72 to form a reproduced image corresponding to a phase modulation pattern.

The optical phase modulation system according to Modification Example 1 has a configuration that facilitates a layout of an optical system at a latter stage from the phase modulation unit 20 as compared with the configuration example illustrated in FIG. 10.

Other configurations and operations are similar to those of the configuration example illustrated in FIG. 10.

### (Modification Example 2)

FIG. 18 schematically illustrates a configuration example of an optical phase modulation system according to Modification Example 2.

The optical phase modulation system according to Modification Example 2 has a configuration as in the configuration example illustrated in FIG. 10 except that the phase modulation unit 20 includes one optical phase modulation device 30 illustrated in FIG. 9.

Other configurations and operations are similar to those of the configuration example illustrated in FIG. 10.

### (Modification Example 3)

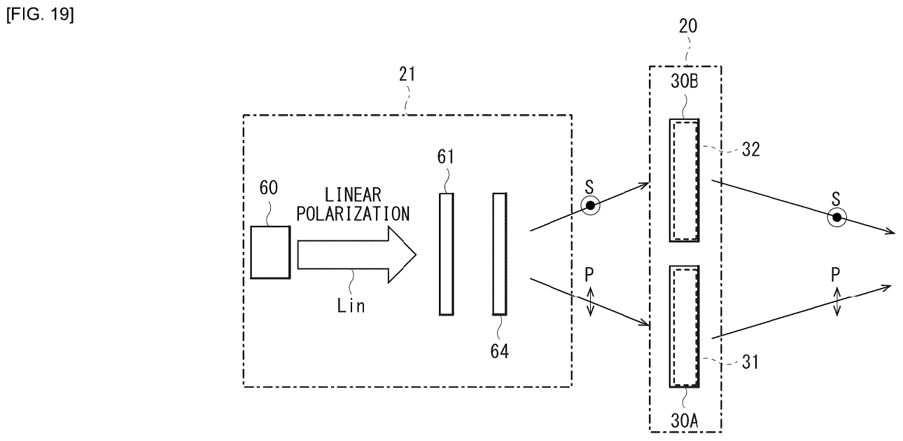

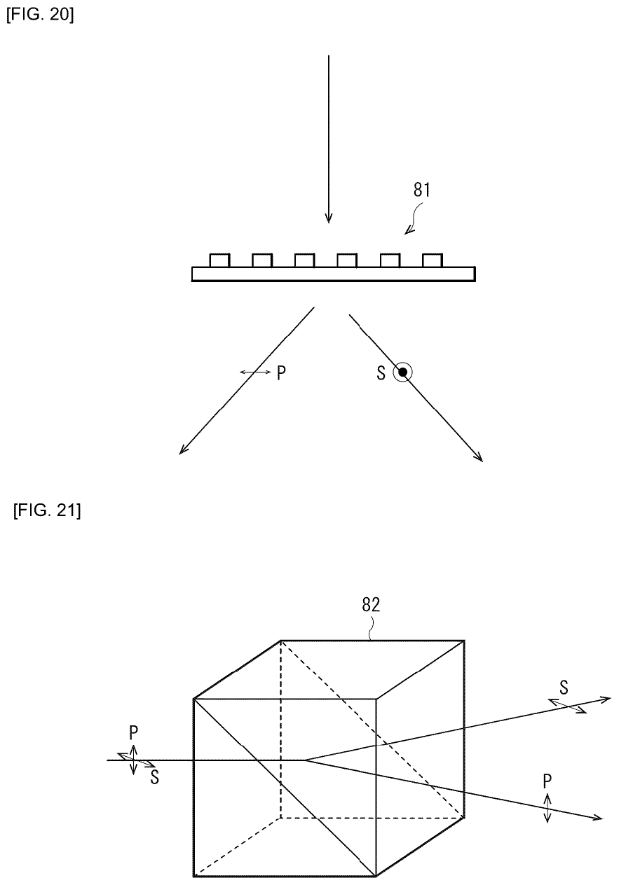

FIG. 19 schematically illustrates a configuration example of an optical phase modulation system according to Modification Example 3.

The optical phase modulation system according to Modification Example 3 has a configuration as in the configuration example illustrated in FIG. 10 except that a polarization spectroscopy device 64 is used instead of the polarization beam splitter 62 as an optical path branching device that causes an optical path to be branched into an optical path of light having the first polarization direction and an optical path of light having the second polarization direction.

FIG. 20 schematically illustrates a first configuration example of the polarization spectroscopy device 64. FIG. 21 schematically illustrates a second configuration example of the polarization spectroscopy device 64. The polarization spectroscopy device 64 may be, for example, a metasurface polarization spectroscopy device 81 as illustrated in FIG. 20. Alternatively, the polarization spectroscopy device 64 may be, for example, a polarization prism 82 as illustrated in FIG. 21.

In the optical phase modulation system according to Modification Example 3, the linearly polarized light from the light source 60 enters the polarization rotation device 61 as the entering light Lin. The polarization rotation device 61 performs the polarization control on the polarization direction of the entering light Lin into the P-polarized light and the S-polarized light, and emits the P-polarized light and the S-polarized light. The P-polarized light enters the first region 31 (the first optical phase modulation device 30A) of the phase modulation unit 20 via the polarization spectroscopy device 64, and is phase-modulated in the first region 31. The S-polarized light enters the second region 32 (the second optical phase modulation device 30B) of the phase modulation unit 20 via the polarization spectroscopy device 64, and is phase-modulated in the second region 32. The P-polarized light and the S-polarized light after the phase modulation are emitted in the same direction to form a reproduced image corresponding to a phase modulation pattern.

Other configurations and operations are similar to those of the configuration example illustrated in FIG. 10.

### (Modification Example 4)

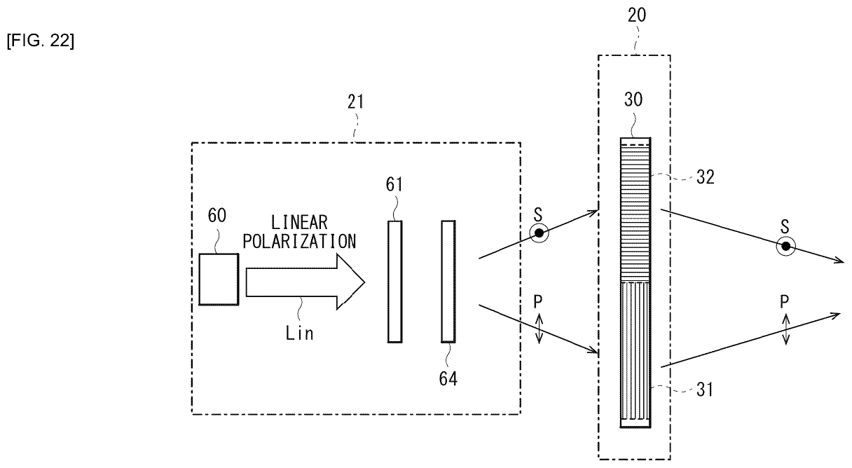

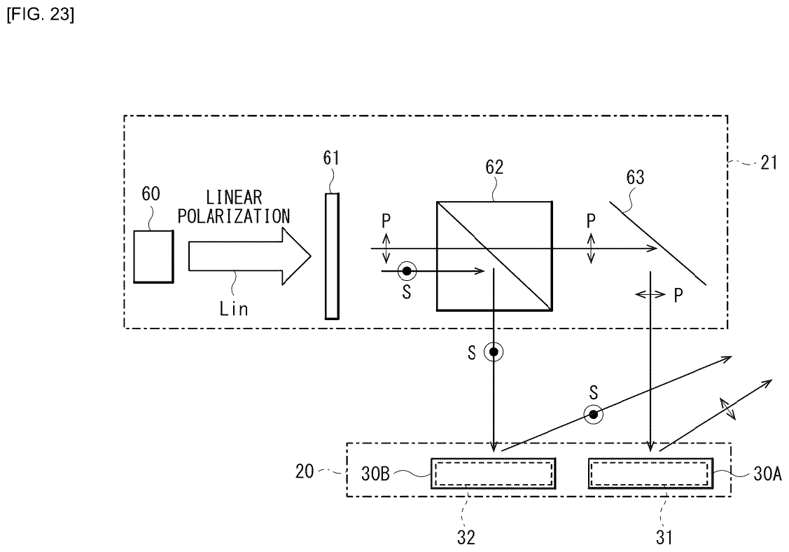

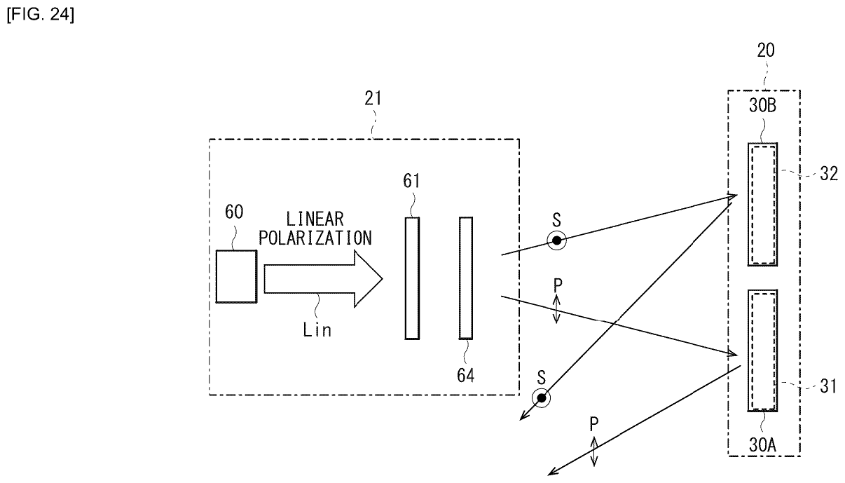

FIG. 22 schematically illustrates a configuration example of an optical phase modulation system according to Modification Example 4.

The optical phase modulation system according to Modification Example 2 has a configuration as in Modification Example 3 illustrated in FIG. 19 except that the phase modulation unit 20 includes one optical phase modulation device 30 illustrated in FIG. 9.

Other configurations and operations are similar to those of Modification Example 3 illustrated in FIG. 19.

### (Modification Example 5)

FIG. 23 schematically illustrates a configuration example of an optical phase modulation system according to Modification Example 5.

The optical phase modulation system according to Modification Example 5 has a configuration as in the configuration example illustrated in FIG. 10 except that the first optical phase modulation device 30A and the second optical phase modulation device 30B include a reflective optical phase modulation device.

Other configurations and operations are similar to those of the configuration example illustrated in FIG. 10.

### (Modification Example 6)

FIG. 24 schematically illustrates a configuration example of an optical phase modulation system according to Modification Example 6.

The optical phase modulation system according to Modification Example 6 has a configuration as in Modification Example 3 illustrated in FIG. 19 except that the first optical phase modulation device 30A and the second optical phase modulation device 30B include a reflective optical phase modulation device.

Other configurations and operations are similar to those of Modification Example 3 illustrated in FIG. 19.

### (Modification Example 7)

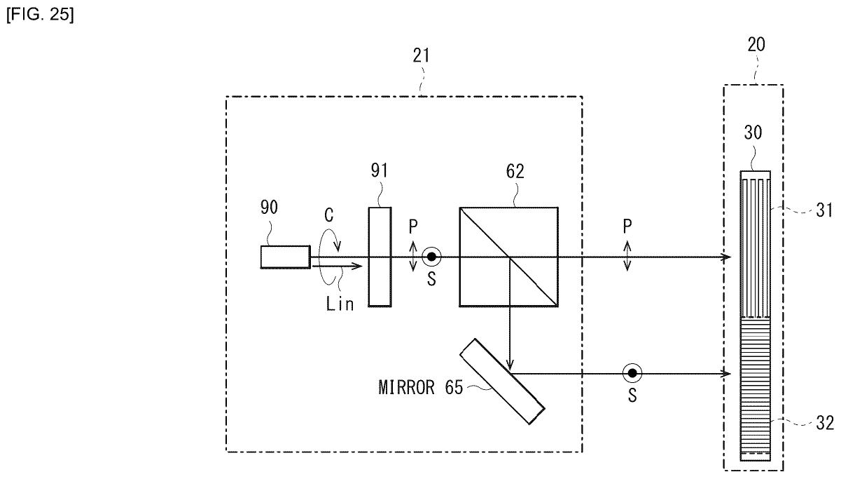

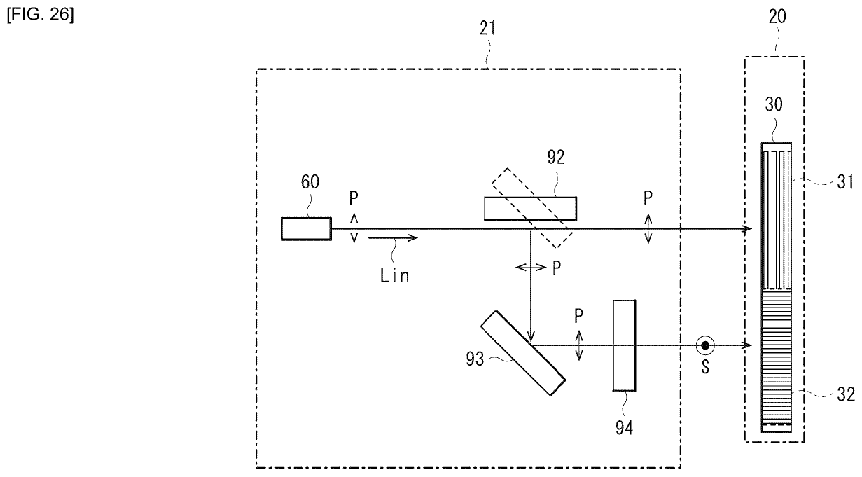

FIG. 25 schematically illustrates a configuration example of an optical phase modulation system according to Modification Example 7.

In the optical phase modulation system according to Modification Example 7, the illumination light emitter 21 includes a light source 90, a rotary quarter-wave plate 91, the polarization beam splitter (PBS) 62, and a mirror 65. Further, the optical phase modulation system according to Modification Example 7 includes the phase modulation unit 20 including one optical phase modulation device 30 illustrated in FIG. 9. Note that the phase modulation unit 20 may further be configured to include the first optical phase modulation device 30A and the second optical phase modulation device 30B similarly to the configuration example illustrated in FIG. 10.

The light source 90 is a circularly polarized light source that emits circularly polarized light. The rotary quarter-wave plate 91 is a polarization rotation device configured to mechanically rotate the polarization direction of light, and is a rotary quarter-wave plate including a mechanical rotation mechanism. The polarization beam splitter 62 is an optical path branching device that causes an optical path to be branched into an optical path of light having the first polarization direction (the P-polarized light) and an optical path of light having the second polarization direction (the S-polarized light).

In the optical phase modulation system according to Modification Example 7, the circularly polarized light from the light source 90 enters the rotary quarter-wave plate 91 as the entering light Lin. The rotary quarter-wave plate 91 performs the polarization control on the polarization direction of the entering light Lin into the P-polarized light and the S-polarized light, and emits the P-polarized light and the S-polarized light. The P-polarized light enters the first region 31 of the phase modulation unit 20 via the polarization beam splitter 62, and is phase-modulated in the first region 31. The S-polarized light enters the second region 32 of the phase modulation unit 20 via the polarization beam splitter 62 and the mirror 65, and is phase-modulated in the second region 32. The P-polarized light and the S-polarized light after the phase modulation are emitted in the same direction to form a reproduced image corresponding to a phase modulation pattern.

The synchronization control unit 22 causes timing of the polarization control by the rotary quarter-wave plate 91 to be synchronized with timing of the phase modulation in the first region 31 and the second region 32 of the phase modulation unit 20. The illumination light emitted from the rotary quarter-wave plate 91 illuminates either the first region 31 or the second region 32 of the phase modulation unit 20 in accordance with the polarization direction thereof. The synchronization control unit 22 controls the rotary quarter-wave plate 91 to rotate the polarization direction of the illumination light in accordance with a response completion time of the liquid crystal in each of the first region 31 and the second region 32. Thus, the phase modulation pattern is displayed in each of the first region 31 and the second region 32 alternately.

The optical phase modulation system according to Modification Example 7 is configured to improve the light use efficiency.

### (Modification Example 8)

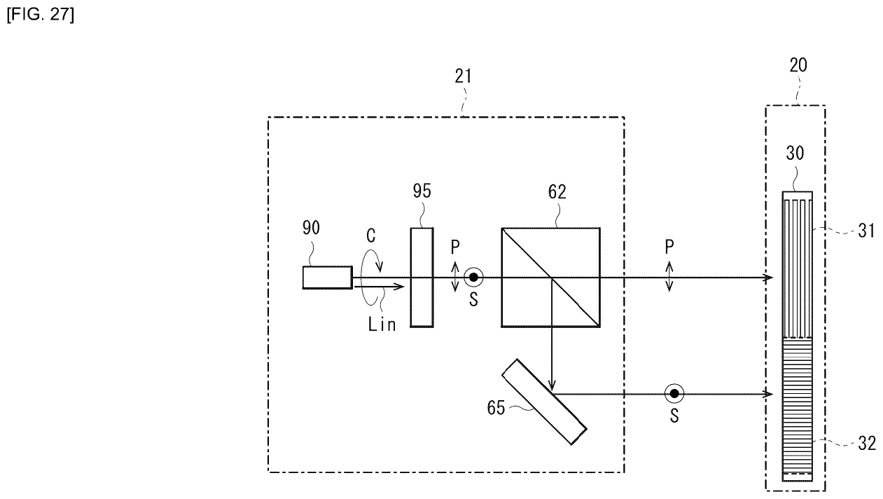

FIG. 26 schematically illustrates a configuration example of an optical phase modulation system according to Modification Example 8.

In the optical phase modulation system according to Modification Example 8, the illumination light emitter 21 includes the light source 60, a galvanometer mirror 92, a mirror 93, and a half-wave plate 94. Further, the optical phase modulation system according to Modification Example 8 includes the phase modulation unit 20 including one optical phase modulation device 30 illustrated in FIG. 9. Note that the phase modulation unit 20 may further be configured to include the first optical phase modulation device 30A and the second optical phase modulation device 30B similarly to the configuration example illustrated in FIG. 10.

The light source 60 is, for example, a laser light source that emits P-polarized light as linearly polarized light. The galvanometer mirror 92 is an optical path switching device that switches the optical path of the illumination light between a first optical path and a second optical path different from the first optical path. The half-wave plate 94 is a polarization conversion device that is disposed on the second optical path and converts the polarization direction of light from the first polarization direction (the P-polarized light) to the second polarization direction (the S-polarized light).

In the optical phase modulation system according to Modification Example 8, the linearly polarized light (the P-polarized light) from the light source 60 enters the galvanometer mirror 92 as the entering light Lin. The galvanometer mirror 92 switches the optical path according to which of the first region 31 and the second region 32 of the phase modulation unit 20 the illumination light is to be caused to enter. When the optical path is switched to the first optical path by the galvanometer mirror 92, the P-polarized light enters the first region 31 of the phase modulation unit 20 as illumination light, and phase modulation is performed in the first region 31. When the optical path is switched to the second optical path by the galvanometer mirror 92, the P-polarized light enters the half-wave plate 94 via the mirror 93 and is converted into the S-polarized light. The S-polarized light enters the second region 32 of the phase modulation unit 20, and phase modulation is performed in the second region 32. The P-polarized light and the S-polarized light after the phase modulation are emitted in the same direction to form a reproduced image corresponding to a phase modulation pattern.

The synchronization control unit 22 causes timing of the switching of the optical path by the galvanometer mirror 92 to be synchronized with timing of the phase modulation in the first region 31 and the second region 32 of the phase modulation unit 20. Thus, the phase modulation pattern is displayed in each of the first region 31 and the second region 32 alternately.

The optical phase modulation system according to Modification Example 8 is configured to improve the light use efficiency. Additionally, it is possible to control the polarization only with a typical optical device.

### (Modification Example 9)

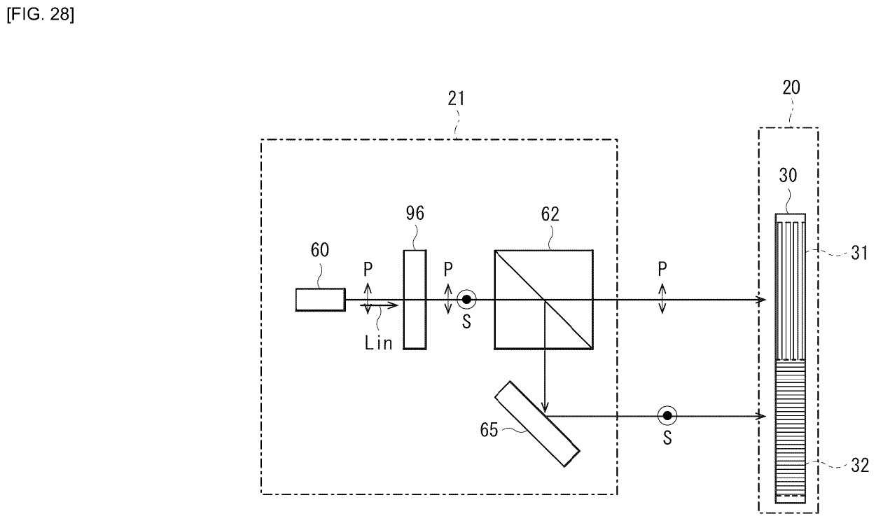

FIG. 27 schematically illustrates a configuration example of an optical phase modulation system according to Modification Example 9.

In the optical phase modulation system according to Modification Example 9, a nematic liquid crystal device 95 is used as a polarization rotation device instead of the rotary quarter-wave plate 91 in Modification Example 7 illustrated in FIG. 25.

In the optical phase modulation system according to Modification Example 9, the circularly polarized light from the light source 90 enters the nematic liquid crystal device 95 as the entering light Lin. The nematic liquid crystal device 95 performs the polarization control on the polarization direction of the entering light Lin into the P-polarized light and the S-polarized light, and emits the P-polarized light and the S-polarized light. The synchronization control unit 22 causes timing of the polarization control by the nematic liquid crystal device 95 to be synchronized with timing of the phase modulation in the first region 31 and the second region 32 of the phase modulation unit 20.

Other configurations and operations are similar to those of Modification Example 7 illustrated in FIG. 25.

### (Modification Example 10)

FIG. 28 schematically illustrates a configuration example of an optical phase modulation system according to Modification Example 10.

In the optical phase modulation system according to Modification Example 10, a ferroelectric liquid crystal device 96 is used as a polarization rotation device instead of the rotary quarter-wave plate 91 in Modification Example 7 illustrated in FIG. 25. Further, instead of the light source 90 that emits the circularly polarized light, the light source 60 that emits the P-polarized light as the linearly polarized light is used.

In the optical phase modulation system according to Modification Example 10, the P-polarized light from the light source 60 enters the ferroelectric liquid crystal device 96 as the entering light Lin. The ferroelectric liquid crystal device 96 performs the polarization control on the polarization direction of the entering light Lin into the P-polarized light and the S-polarized light, and emits the P-polarized light and the S-polarized light. The synchronization control unit 22 causes timing of the polarization control by the ferroelectric liquid crystal device 96 to be synchronized with timing of the phase modulation in the first region 31 and the second region 32 of the phase modulation unit 20.

Other configurations and operations are similar to those of Modification Example 7 illustrated in FIG. 25.

### [1.3 Effects]

As described above, according to the optical phase modulation system of the first embodiment, the light having the first polarization direction and the light having the second polarization direction are emitted from the illumination light emitter 21 at different timing, and the light having the first polarization direction and the light having the second polarization direction are respectively phase-modulated in the first region 31 and the second region 32 of the phase modulation unit 20. At this time, the timing of emitting light having each polarization direction is caused to be synchronized with the timing of the phase modulation in each region. This makes it possible to suppress degradation in the image quality while improving the response speed of the phase modulation.

According to the optical phase modulation system of the first embodiment, it is possible to relieve a delay in the response speed when the optical phase modulation device having a phase modulation amount of 0 to 2π is used by alternately using the two regions of the phase modulation unit 20. At this time, it is possible to increase the frame speed without deteriorating the image quality or decreasing the luminance (the efficiency). Further, because the light that enters the two regions of the phase modulation unit 20 maintains the wavefront (a plane) from the illumination light, it is possible to easily calculate the phase pattern to display any distribution.

Note that the effects described in the present specification are merely examples and are not limitative, and other effects may be achieved. The same applies to the effects of the following other embodiments.

### <2. Other Embodiments>

The technique according to the present disclosure is not limited to the description of the above-described embodiments, and is modifiable in a variety of ways.

For example, it is possible for the present technology to have the configuration as follows.

According to the present technology having the following configuration, the light having the first polarization direction and the light having the second polarization direction are emitted from the illumination light emitter at different timing, and the light having the first polarization direction and the light having the second polarization direction are respectively phase-modulated in the first region and the second region of the phase modulation unit. At this time, the timing of emitting light having each polarization direction is caused to be synchronized with the timing of the phase modulation in each region. This makes it possible to suppress degradation in the image quality while improving the response speed of the phase modulation.

(1)

An optical phase modulation system including:
an illumination light emitter configured to perform polarization control on a polarization direction of light emitted as illumination light into a first polarization direction and a second polarization direction different from the first polarization direction, and configured to emit light having the first polarization direction and light having the second polarization direction at different timing from each other and in different directions from each other;
a phase modulation unit including a first region configured to perform phase modulation on the light having the first polarization direction from the illumination light emitter, and a second region configured to perform phase modulation on the light having the second polarization direction from the illumination light emitter; and
a synchronization control unit that causes timing at which the light having the first polarization direction and the light having the second polarization direction are emitted from the illumination light emitter to be synchronized with timing of phase modulation in the first region and the second region of the phase modulation unit.
   (2)

The optical phase modulation system according to (1), in which the synchronization control unit causes timing at which the light having the first polarization direction is emitted from the illumination light emitter to be synchronized with timing at which phase modulation of the light having the first polarization direction is performed in the first region, and causes timing at which the light having the second polarization direction is emitted from the illumination light emitter to be synchronized with timing at which phase modulation of the light having the second polarization direction is performed in the second region.

(3)

The optical phase modulation system according to (1), in which the phase modulation unit includes a first optical phase modulation device including the first region, and a second optical phase modulation device including the second region.

(4)

The optical phase modulation system according to (1), in which the phase modulation unit includes an optical phase modulation device including the first region and the second region.

(5)

The optical phase modulation system according to (1), in which
the illumination light emitter includes
   a polarization rotation device that performs polarization control on the polarization direction of light into the first polarization direction and the second polarization direction, and
   an optical path branching device that causes an optical path to be branched into an optical path of the light having the first polarization direction and an optical path of the light having the second polarization direction, and
the synchronization control unit causes timing at which the polarization control is performed by the polarization rotation device to be synchronized with timing of phase modulation in the first region and the second region of the phase modulation unit.
   (6)

The optical phase modulation system according to (5), in which the polarization rotation device includes a device configured to electrically rotate the polarization direction of light.

(7)

The optical phase modulation system according to (6), in which the polarization rotation device includes a liquid crystal device.

(8)

The optical phase modulation system according to (5), in which the polarization rotation device includes a device configured to mechanically rotate the polarization direction of light.

(9)

The optical phase modulation system according to (8), in which the polarization rotation device includes a rotary wave plate including a mechanical rotation mechanism.

(10)

The optical phase modulation system according to (5), in which the optical path branching device includes a polarization beam splitter.

(11)

The optical phase modulation system according to (5), in which the optical path branching device includes a polarization spectroscopy device.

(12)

The optical phase modulation system according to (1), in which
the illumination light emitter includes
   an optical path switching device that switches an optical path of the illumination light to a first optical path and a second optical path different from the first optical path, and
   a polarization conversion device that is disposed on the second optical path and converts the polarization direction of light from the first polarization direction to the second polarization direction, and
the synchronization control unit causes timing at which the optical path is switched by the optical path switching device to be synchronized with timing of phase modulation in the first region and the second region of the phase modulation unit.
   (13)

The optical phase modulation system according to (1), in which the illumination light emitter includes a light source that emits linearly polarized light.

(14)

The optical phase modulation system according to (1), in which the illumination light emitter includes a light source that emits circularly polarized light.

(15)

A display unit including:
an illumination light emitter configured to perform polarization control on a polarization direction of light emitted as illumination light into a first polarization direction and a second polarization direction different from the first polarization direction, and configured to emit light having the first polarization direction and light having the second polarization direction at different timing from each other and in different directions from each other;
a phase modulation unit including a first region configured to perform phase modulation on the light having the first polarization direction from the illumination light emitter, and a second region configured to perform phase modulation on the light having the second polarization direction from the illumination light emitter; and
a synchronization control unit that causes timing at which the polarization control is performed by the illumination light emitter to be synchronized with timing of phase modulation in the first region and the second region of the phase modulation unit.

The present application claims the benefit of Japanese Priority Patent Application JP2021-194909 filed with the Japan Patent Office on Nov. 30, 2021, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. An optical phase modulation system comprising:
an illumination light emitter configured to perform polarization control on a polarization direction of light emitted as illumination light into a first polarization direction and a second polarization direction different from the first polarization direction, and configured to emit light having the first polarization direction and light having the second polarization direction at different timing from each other and in different directions from each other;
a phase modulation unit including a first region configured to perform phase modulation on the light having the first polarization direction from the illumination light emitter, and a second region configured to perform phase modulation on the light having the second polarization direction from the illumination light emitter; and
a synchronization control unit that causes timing at which the light having the first polarization direction and the light having the second polarization direction are emitted from the illumination light emitter to be synchronized with timing of phase modulation in the first region and the second region of the phase modulation unit.

2. The optical phase modulation system according to claim 1, wherein the synchronization control unit causes timing at which the light having the first polarization direction is emitted from the illumination light emitter to be synchronized with timing at which phase modulation of the light having the first polarization direction is performed in the first region, and causes timing at which the light having the second polarization direction is emitted from the illumination light emitter to be synchronized with timing at which phase modulation of the light having the second polarization direction is performed in the second region.

3. The optical phase modulation system according to claim 1, wherein the phase modulation unit includes
a first optical phase modulation device including the first region, and
a second optical phase modulation device including the second region.

4. The optical phase modulation system according to claim 1, wherein the phase modulation unit includes an optical phase modulation device including the first region and the second region.

5. The optical phase modulation system according to claim 1, wherein
the illumination light emitter includes
a polarization rotation device that performs polarization control on the polarization direction of light into the first polarization direction and the second polarization direction, and
an optical path branching device that causes an optical path to be branched into an optical path of the light having the first polarization direction and an optical path of the light having the second polarization direction, and
the synchronization control unit causes timing at which the polarization control is performed by the polarization rotation device to be synchronized with timing of phase modulation in the first region and the second region of the phase modulation unit.

6. The optical phase modulation system according to claim 5, wherein the polarization rotation device comprises a device configured to electrically rotate the polarization direction of light.

7. The optical phase modulation system according to claim 6, wherein the polarization rotation device comprises a liquid crystal device.

8. The optical phase modulation system according to claim 5, wherein the polarization rotation device comprises a device configured to mechanically rotate the polarization direction of light.

9. The optical phase modulation system according to claim 8, wherein the polarization rotation device comprises a rotary wave plate including a mechanical rotation mechanism.

10. The optical phase modulation system according to claim 5, wherein the optical path branching device comprises a polarization beam splitter.

11. The optical phase modulation system according to claim 5, wherein the optical path branching device comprises a polarization spectroscopy device.

12. The optical phase modulation system according to claim 1, wherein
the illumination light emitter includes
an optical path switching device that switches an optical path of the illumination light to a first optical path and a second optical path different from the first optical path, and
a polarization conversion device that is disposed on the second optical path and converts the polarization direction of light from the first polarization direction to the second polarization direction, and
the synchronization control unit causes timing at which the optical path is switched by the optical path switching device to be synchronized with timing of phase modulation in the first region and the second region of the phase modulation unit.

13. The optical phase modulation system according to claim 1, wherein the illumination light emitter includes a light source that emits linearly polarized light.

14. The optical phase modulation system according to claim 1, wherein the illumination light emitter includes a light source that emits circularly polarized light.

15. A display unit comprising:
an illumination light emitter configured to perform polarization control on a polarization direction of light emitted as illumination light into a first polarization direction and a second polarization direction different from the first polarization direction, and configured to emit light having the first polarization direction and light having the second polarization direction at different timing from each other and in different directions from each other;
a phase modulation unit including a first region configured to perform phase modulation on the light having the first polarization direction from the illumination light emitter, and a second region configured to perform phase modulation on the light having the second polarization direction from the illumination light emitter; and
a synchronization control unit that causes timing at which the polarization control is performed by the illumination light emitter to be synchronized with timing of phase modulation in the first region and the second region of the phase modulation unit.
